(19) United States
(12) Patent Application Publication
(10) Pub. No.: US 2015/0294313 A1
(43) Pub. Date: Oct. 15, 2015

(54) SYSTEMS, APPARATUS AND METHODS FOR IMPROVED AUTHENTICATION

(71) Applicant: MasterCard International Incorporated, Purchase, NY (US)

(72) Inventors: Ashfaq Kamal, White Plains, NY (US); Gregory D. Williamson, Stamford, CT (US); Steve Hubbard, Leicester (GB); Bob Reany, Stamford, CT (US)

(21) Appl. No.: 14/684,749

(22) Filed: Apr. 13, 2015

Related U.S. Application Data
(60) Provisional application No. 61/979,301, filed on Apr. 14, 2014.

(51) Int. Cl. G06Q 20/40; G06Q 20/32

(52) U.S. Cl. CPC G06Q 20/401; G06Q 20/322

(57) ABSTRACT

Multi-factor authentication techniques are described that use secure push authentication technology for transactions. An embodiment includes receiving, by an assurance platform operating as an authentication service platform, a user authentication request and transaction data from an access control server (ACS), determining an authentication rule, generating a user validation request message, transmitting the user validation request message to a user mobile device, and receiving user authentication data. The assurance platform then validates the user authentication data, transmits a device authentication request, receives a device authentication response signed with a private key of the user, and authenticates the user based on the device authentication response and private key.

### CROSS REFERENCE TO RELATED APPLICATION

This application claims the benefit of U.S. Provisional Patent Application No. 61/979,301 filed on Apr. 14, 2014, the contents of which are hereby incorporated by reference for all purposes.

### FIELD OF THE INVENTION

Embodiments of the present invention described herein generally relate to authentication techniques. More particularly, embodiments relate to multi-factor authentication techniques utilizing secure push authentication technology usable in transactions such as payment transactions.

### BACKGROUND OF THE INVENTION

More and more transactions involve a user operating a mobile device. A common example of a transaction is a payment transaction, although a large number of other types of transactions that require user authentication are known. In many types of transactions, it is increasingly important that the user involved in such transactions be authenticated. Often, the user is authenticated using a personal identification number (“PIN”) or the like. However, it is becoming increasingly important to provide additional authentication layers (referred to herein as “multi-factor” authentication) for improved security and improved authentication.

Card issuers and other financial institutions now offer or use standardized Internet transaction protocols to improve online transaction performance and to accelerate the growth of electronic commerce. Under some standardized protocols, card issuers or issuing banks may authenticate transactions thereby reducing the likelihood of fraud and associated chargebacks attributed to cardholder not-authorized transactions. One example of such a standardized protocol is the 3-D Secure Protocol. The presence of an authenticated transaction may result in an issuer assuming liability for fraud, should it occur, despite efforts to authenticate the cardholder during an online purchase (sometimes called a “card not-present”or “CNP” transaction). Merchants are assured by card issuers or issuing banks that they will be paid for issuer-authenticated transactions. The 3-D Secure protocol is consistent with and underlies the authentication programs offered by card issuers (for example, Verified by Visa™ and/or MasterCard® SecureCode™) to authenticate customers for merchants during remote transactions such as those associated with the Internet.

The 3-D Secure Protocol leverages existing Secure Sockets layer (SSL) encryption functionality and provides enhanced security through issuer authentication of the cardholder during the online shopping session. It would be desirable to provide multi-factor authentication technologies in such transactions.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments, wherein:

FIG. 1 is a block diagram of a transaction system according to an embodiment of the disclosure;

FIG. 2A is a block diagram of a portion of a transaction system used to perform a device registration and user registration process pursuant to some embodiments in accordance with the disclosure;

FIG. 2B is a flowchart illustrating a device registration process in accordance with some embodiments of the disclosure;

FIG. 3A is a block diagram of a portion of a transaction system used to allow a user to add entities pursuant to some embodiments in accordance with the disclosure;

FIG. 3B is a flowchart illustrating a process for allowing a registered user to add entities to associate with the user device pursuant in accordance with some embodiments of the disclosure;

FIG. 4A is a block diagram of a portion of a transaction system for use in performing a transaction pursuant to some embodiments in accordance with the disclosure; and

FIG. 4B is a flowchart illustrating an example of a multi-factor authentication process using secure push authentication technology in accordance with some embodiments of the disclosure.

### DETAILED DESCRIPTION

In general, and for the purpose of introducing concepts of novel embodiments described herein, provided are systems, apparatus and methods for providing an improved authentication system for transactions including, for example, financial transactions.

In some embodiments, improved authentication techniques and methods are provided which allow an improved user experience for both merchants and consumers, especially when used in conjunction with transactions involving mobile devices.

Further, in some embodiments, authentication techniques may include additional authentication levels that may be determined by a financial institution such as a card issuer and/or by a cardholder and/or that may be determined on a transaction by transaction basis. Such operation or functionality allows for the authentication required for a given transaction to be enhanced in some situations. For example, if a payment transaction is greater than a predetermined threshold value (which may be preset by, for example, an issuer bank or the cardholder), then an additional level of authentication is required. The additional level of authentication may involve prompting the cardholder to provide biometric data within the capabilities of his or her mobile device. In addition, embodiments described herein facilitate adoption of such authentication techniques, as well as reduce declined transactions which are legitimate “card not-present” (CNP) transactions.

Pursuant to some embodiments, a user's connected mobile wireless device (such as a smart phone, tablet computer, digital music player, laptop computer, smart watch, personal digital assistant (PDA), or the like) can be leveraged to provide additional factors for authentication in online transactions. Embodiments utilize secure push authentication technology and/or techniques with mobile devices to deliver an optimal user experience, and to deliver layered authentication factors. For example, authentication technologies such as finger print biometrics, facial recognition applications, voice biometric applications and others may be utilized with the architecture described herein. Embodiments utilize an authentication platform (which will be described further herein) to allow an identification of the appropriate authentication process(es) to be used in particular transactions for a given user. In particular, the authentication platform may be used in conjunction with a number of different types of transaction processes to provide the appropriate authentication. For convenience, payment transactions and/or financial transactions are described herein, however, those skilled in the art, upon reading this disclosure, will appreciate that the described authentication techniques may be used with desirable results in other types of transactions that require user authentication.

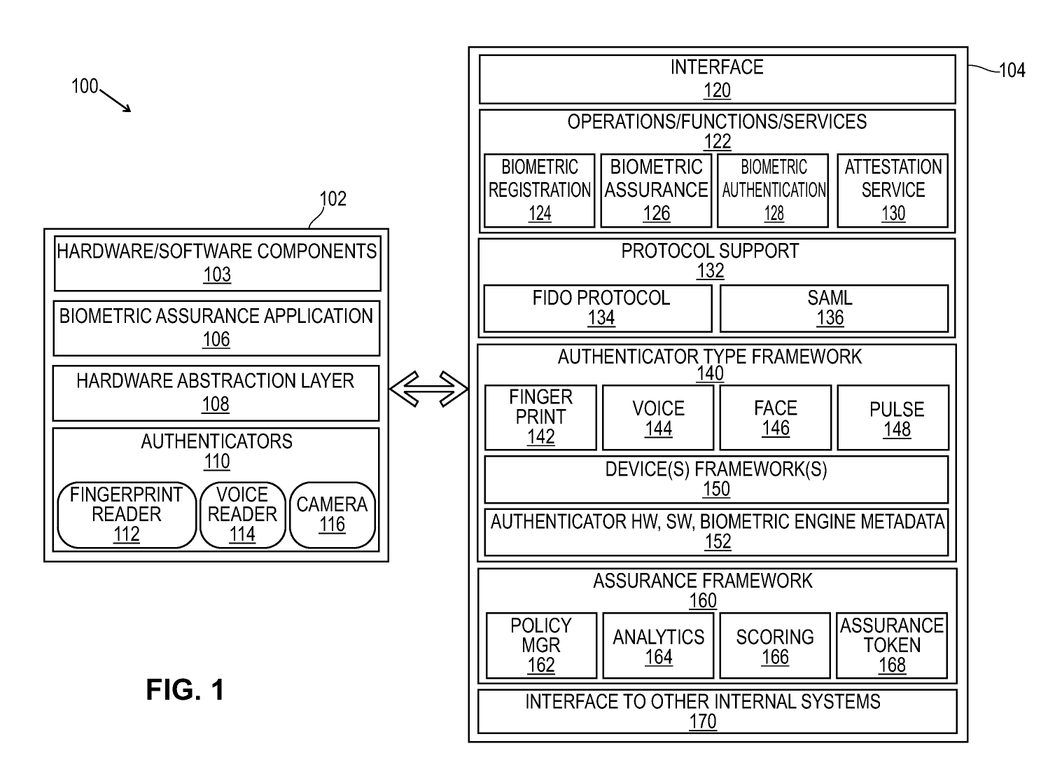

Features of some embodiments will now be described by reference to FIG. 1, which is a block diagram 100 illustrating the components of a portion of a transaction system pursuant to some embodiments. A transaction system pursuant to some embodiments involves a number of devices and entities interacting to conduct a transaction. For example, users may operate mobile devices 102 to interact with an assurance service platform 104 in accordance with the novel aspects described herein. It should be understood that, while only a single mobile device 102 and a single assurance service platform 104 are shown in FIG. 1, in practice a large number of such devices may be involved in a system in accordance with the novel aspects disclosed herein.

As shown in FIG. 1, the mobile device 102 includes hardware and/or software components 103 that provide functionality and/or operations in accordance with the characteristics of that type of mobile device. For example, if the mobile device is a smartphone, then it may include hardware components such as a touch screen display, a microphone, a speaker, controller circuitry, an antenna, a memory or storage device and a camera (not shown) in addition to software configured to provide smartphone functionality. Storage devices utilized in the devices and/or system components described herein may be composed of or be any type of non-transitory storage device that may store instructions and/or software for causing one or more processors of such electronic devices to function in accordance with the novel aspects disclosed herein.

The mobile device 102 of FIG. 1 may also include a number of logical and/or functional components (in addition to the normal components found in a mobile device). For example, as shown in FIG. 1, some of these additional logical and/or functional components include, but are not limited to, a biometric assurance application 106 (or other software and/or middleware components to provide the functionality) as well as a hardware abstraction layer 108 that allows interaction with a number of hardware components or authenticators 110. The authenticators 110 may perform various different types of authentication, and may include one or more of a fingerprint reader 112, a voice reader 114, and/or a digital camera 116. For example, the digital camera 116 may be utilized in some circumstances to capture a photograph of the user's face to perform a facial recognition process or the like during a transaction. It should be understood that some mobile devices 102 may include two or more of such authenticators 110 in different combinations (for example, a smartphone may include a voice reader 114 and a camera 116, but not a fingerprint reader 112, while other types of mobile devices may include all three of these devices). Moreover, some types of mobile devices may only include one type of authenticator, for example a microphone.

Pursuant to some embodiments, some of the authentication components of the mobile device 102 may be configured based on, or using a standard such as, the so-called “FIDO” standards promulgated by the Fast Identity Online Alliance (available at www.fidoalliance.org, and incorporated herein by reference in their entirety for all purposes). The Fast Identity Online Alliance is an industry consortium formed to address the lack of interoperability among strong authentication devices and the problems that users face creating and remembering multiple usernames and passwords. It should be understood, however, that other standards or implementations may also be used with desirable results in accordance with the novel processes described herein.

Referring again to FIG. 1, the mobile device 102 may be in communication with an assurance platform 104. As shown, the assurance platform 104 includes a number of components that allow the assurance platform 104 to interact with a mobile device 102 to perform an authentication process pursuant to the novel aspects described herein. The assurance platform 104 also includes components that may be utilized to register information associated with mobile devices and other system participants (such as, for example, information from financial institutions or other entities that wish to utilize the features of the novel systems and/or processes disclosed herein for authentication processing). In particular, the assurance platform 104 may include components including an interface 120, which may be implemented as a Web service (which is a method of communicating between two electronic devices over a network) using Simple Object Access Protocol (SOAP) and/or Representational State Transfer (REST) or other techniques, which allows communication between mobile devices 102 and other entities. Thus, the interface 120 may be a SOAP/REST interface.

FIG. 1 also illustrates that the assurance platform 104 may provide a number of operations, functions and/or services 122 (and which may be accessible using the Web service interface 120). Such functions and services may include, for example, a biometric registration component 124, a biometric assurance component 126, a biometric authentication component 128, and an attestation service component 130. The assurance platform 104 may also include a protocol support component 132 for providing support for different authentication protocols and/or techniques. For example, the protocol support component 132 may include the Fast Identity Online (FIDO) protocol 134 and/or the Security Assertions Markup Language (SAML) protocol 136, or the like. In addition, different authenticator type frameworks 140 may be provided to provide support for different authenticator types. For example, frameworks may be provided to process data associated with user authentication including, but not limited to, fingerprint 142, voice 144, face 146, pulse 148 and/or other types of biometric authentication techniques. Device(s) frameworks 150 may also be provided for different types of devices, such as mobile telephones, tablet computers, laptop computers, digital music players, smart watches, and/or wearable devices and the like. The device frameworks 150 may include information and/or data concerning, for example, different makes and models of such mobile devices, and/or the like data, as well as data concerning different types of hardware and/or software components associated with such devices. The Authenticator type framework 140 may also include authentication hardware, software and/or biometric engine metadata 152 (which is data that describes and/or gives information about other data, which can make it easier to find and/or work with particular instances of data).

The assurance platform 104 may also provide data and/or components associated with different assurance frameworks 160. The assurance frameworks 160 may include, but are not limited to, a policy manager 162, analytics 164, scoring 166, and assurance token data storage 168. In addition, an interface 170 to other internal systems of the assurance platform 104 may be provided. As will be described in more detail herein, these frameworks and/or components allow a wide variety of devices as well as a wide variety of authentication users to interact in such manner to provide a high level of authentication for a wide variety of different transaction types.

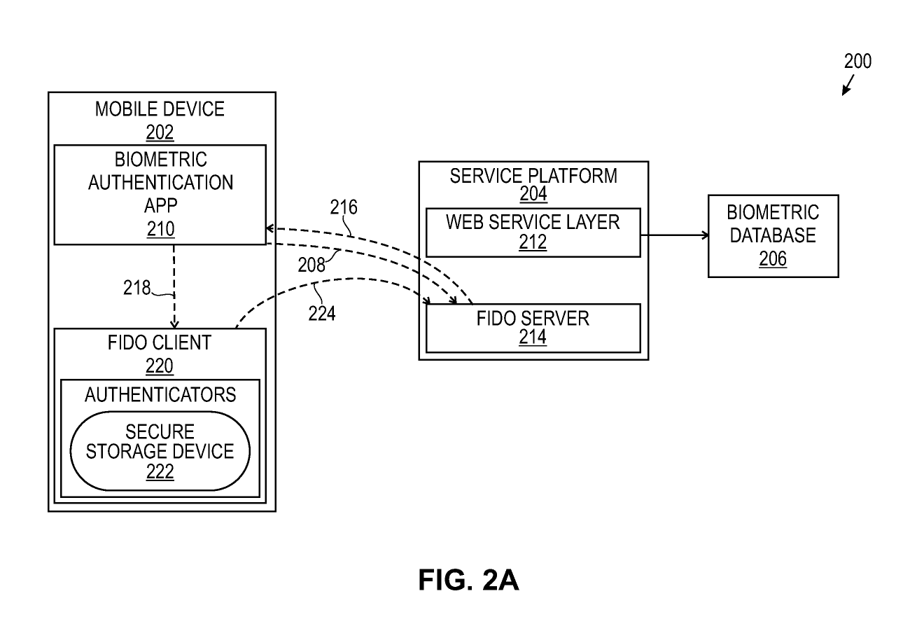

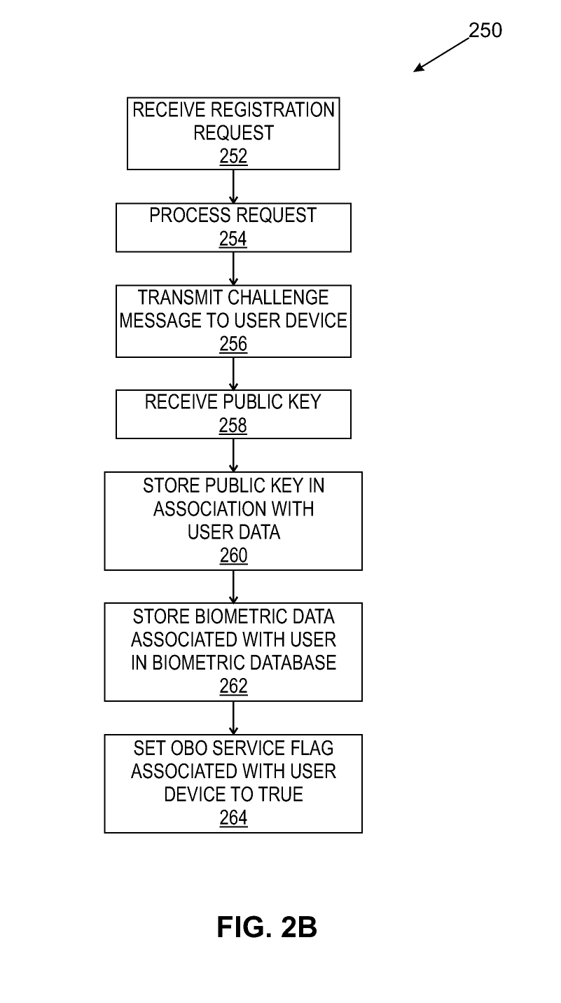

Reference is now made to FIG. 2A where a transaction diagram 200 is shown which depicts portions of different devices that may participate in a device registration and user authentication enrollment process. As shown, a mobile device 202 operated by a user interacts with an assurance platform operated as a service platform 204, which may be in communication with a biometric database 206. In the embodiment shown in FIG. 2A, the transaction utilizes the FIDO protocol; however, those skilled in the art will realize that other protocols may be used.

Referring to FIG. 2A, in an illustrative device registration and biometric enrollment process, a first transaction step 208 may include the mobile device 202 causing a message to be transmitted to the service platform 204 requesting to initiate registration. The message 208 may be created based on a user request to register a device (for example, by interacting with a biometric authentication application that has been loaded onto the mobile device 202). In some embodiments, the user may obtain the biometric authentication application from an application store operated by a third party, from an issuer financial institution, from a merchant website, and/or from another third party and the like. The request message 208 is received by a web service layer 212 in the service platform 204 which routes the request 208 to a FIDO server 214 to initiate the registration of the device. A registration request challenge message is created by the FIDO server and then transmitted 216 to the mobile device 202 which prompts (or challenges) the user to provide the biometric data for use in authentication. For example, if the biometric data to be utilized is fingerprint data, the user may be prompted to place his or her thumb on a fingerprint reader (not shown) associated with his or her mobile device 201 to capture the biometric data. Processing at the mobile device 202 may also include a step 218 to enroll the user and generate a key pair for use in fingerprint authenticated transactions and interactions with the service platform 204. As shown, in some embodiments a FIDO client module 220 generates a key pair for the authentication method and stores it in secure storage device 222 of the mobile device 202. The FIDO client module 220 then causes the user public key to be transmitted 224 to the FIDO Server 214 of the service platform 204 for storage in association with user data (including, in some embodiments, information associated with the biometric data). In some embodiments, the device ID and a mobile directory number (“MDN”) are also transmitted from the mobile device 202 to the service platform 204. In some implementations, the biometric data, the device ID, and the MDN are stored at a biometric database 206 and associated with information from the service platform 204 so that the data may be retrieved as needed to perform authentication as a service in accordance with the processes described herein. In addition, a SOAP/REST application program interface may be implemented to store the biometric data, the device ID and the MDN. The service platform 204 may also store an indication that biometric data is available and/or is stored for a particular device ID and/or MDN by, for example, setting an On-Behalf-Of (OBO) service flag to “true.”

A user may follow the general process described above with regard to FIG. 2A to register a number of biometric data items. For example, a user may generate or create fingerprint biometric data, voice print data, facial data, and/or other data, such as pulse data (which may be based on the user's heartbeat) or the like. In addition, users may register a number of different and/or additional mobile devices (not shown) pursuant to the methods described herein. Further, once the user has registered a device and a biometric dataset, that registration data may be used to authenticate the user with regard to different transactions and involving different transaction methods.

FIG. 2B is a flowchart 250 illustrating a device registration process in accordance with some embodiments. An assurance platform operating as a service platform receives 252 an authentication registration request message from a mobile device being operated by a user. For example, the user may interact with his or her mobile device to initialize a biometric authentication application, and be presented with a biometric authentication user interface displayed on a display component or his or her mobile device. The user enters and/or otherwise provides information into the biometric authentication user interface to generate the authentication registration request message. The biometric authentication user interface may be associated with a biometric authentication application that has been downloaded to the mobile device (for example, from an application store, such as iTunes™ or Google Play™) by the user. The authentication registration request message transmitted from the mobile device may include mobile device data which may identify the type of device by make, model and/or serial number of the device, and such information may be utilized by the service platform to identify the type(s) of authentication hardware components (authenticators) available on the user's mobile device (such as a camera, speaker, microphone, and the like). The authentication registration request message may also include user data, such as a user identifier, mobile telephone number, residence address, billing address and the like.

Referring again to FIG. 2B, the assurance service platform then processes 254 the data in the authentication registration request message, which may include routing the registration request message to a FIDO server to initiate the registration of the user's mobile device. In this case, the FIDO server generates a registration request challenge message which is transmitted 256 to the user's mobile device 202 and which prompts the user to provide biometric data for use in authentication. For example, depending on the capabilities of the user's mobile device, the user may be prompted to take a photograph of his or her face (for facial recognition purposes), and/or to place his or her thumb on a fingerprint reader associated with the user's mobile device to capture fingerprint (biometric) data. In addition, the user's mobile device may also generate a key pair for use in biometric authenticated transactions and for interactions with the assurance service platform, and may send a public key to the assurance service platform along with a mobile device ID and a mobile directory number (“MDN”). Accordingly, in this example the FIDO server of the assurance service platform receives 258 a public key from the user's mobile device, and stores 260 the public key in association with the user data (which includes, in some embodiments, information associated with the biometric data). As mentioned above, a device ID and a mobile directory number (“MDN”) may also be transmitted from the user's mobile device to the assurance platform operating as a service platform. In such cases, the assurance platform operating as a service platform may store 262 biometric data, the device ID, and the MDN in a biometric database and associate that data with information from the assurance platform so that the data may be retrieved as needed to perform authentication as a service in accordance with the processes described herein. A SOAP/REST application program interface may be implemented to store the biometric data, the device ID and the MDN. In addition, the assurance service platform sets 264 an On-Behalf-Of (OBO) service flag to “true” to indicate to a third party device, such as an issuer financial institution server computer and/or a merchant computer, that biometric data is available and/or that such biometric data is stored for a particular device ID and/or MDN which can be used for authentication purposes.

Thus, the assurance service platform stores the biometric data in association with the user data and mobile device data in a biometric database for future use to authenticate the user and/or the user's mobile device when a transaction occurs. Accordingly, in some embodiments the user biometric data, the device ID, and the MDN are all stored in the biometric database and associated with information from the assurance platform so that this data may be retrieved as needed to perform authentication as a service in accordance with the processes described herein. In some embodiments, the assurance platform may utilize a SOAP/REST application program interface to store the biometric data, the device ID and the MDN, and may receive such data from a user to register a number of biometric data items (such as fingerprint biometric data, voice print data, facial data, and/or other data) for one or more of the user's mobile devices. The registration data may then be used by the assurance platform to authenticate a user and/or the user's mobile device in association with different types of transactions which may involve different multi-factor authentication methods.

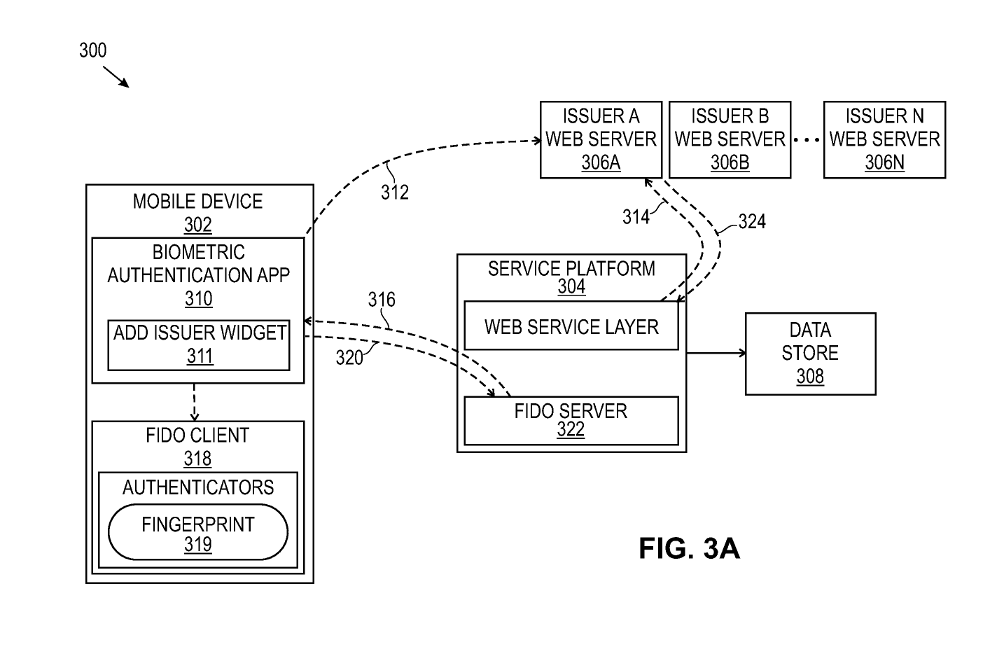

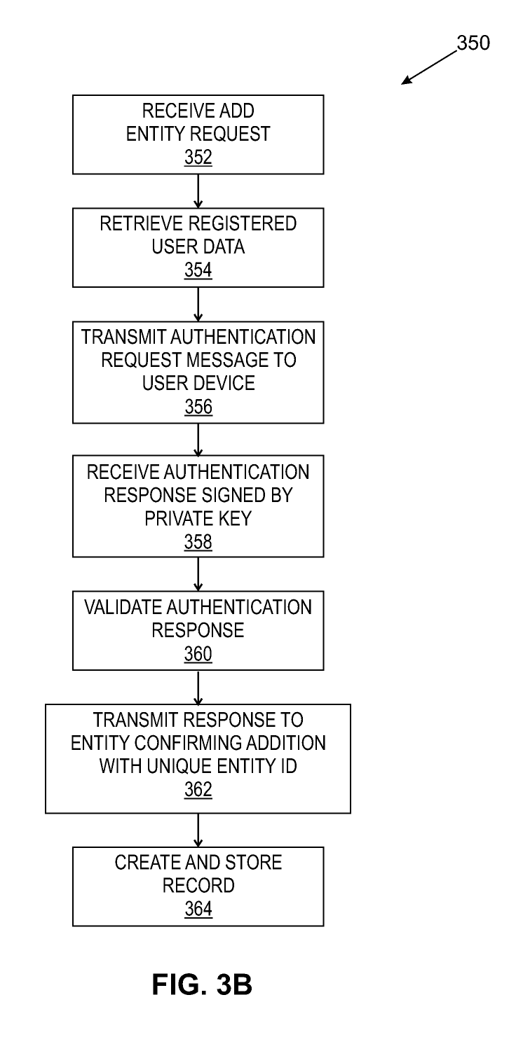

FIG. 3A is a block diagram 300 of a portion of a transaction system used to allow a registered user to add one or more entities for which an authentication method may be used. In particular, a registered user may add an entity with the service platform 304 for use with the authentication processes described herein. For example, if the user wishes to utilize his or her mobile device 302 for payment transactions by utilizing one of the user's payment card accounts, then the user will transmit a request to add the issuer financial institution (such as a credit card issuer bank) that issued the credit card account to the user. Thus, as shown in FIG. 3A, an addition process can involve interaction between the user's device 302, the service platform 304, an “issuer A” web server 306A, and a data store 308. A plurality of issuer web servers, denoted as issuer A web server 306A, issuer B web server 306B and so forth to issuer N web server 306N, are shown because in some cases a particular user may have multiple payment accounts, for example, and he or she may wish to utilize different payment accounts for different purchase transactions and thus add more than one entity (i.e., one or more issuer banks) for use with the authentication methods described herein.

Referring again to FIG. 3A, the user may interact with a biometric authentication application 310 resident on his or her mobile device 302, which may include an “Add issuer widget” 311 program, to initialize a request to add an issuer financial institution or other entity for use with a multi-factor authentication method as described herein. In an embodiment of the process, a request message 312 is transmitted by the user's mobile device 302 to the issuer web server 306A (or a web service on behalf of different issuers). The request message 312 may be generated utilizing the Simple Object Access Protocol (SOAP) messaging protocol or Representational State Transfer (REST) protocol, and may be transmitted by the user's mobile device 302 via the Secure Socket Layer (SSL) protocol or Transport Layer Security (TLS) protocol for security purposes. The request message 312 causes an interaction 314 between the issuer web server 306A and the service platform 304 (for example, the interaction 314 may be a request to add an association between the user or user's mobile device 302 and the issuer A). The service platform 304 retrieves information concerning the registered user and the user's mobile device 302, and then causes an authentication request message 316 to be transmitted to the mobile device 302 (which may include a random challenge to authenticate the user). The biometric authentication application 310 of the mobile device 302 receives the authentication request 316 and causes interaction with the FIDO client 318 on the mobile device 302 to prompt the user to provide his or her fingerprint via the fingerprint authenticator 319, and if the user's fingerprint is successfully authenticated, the FIDO client 318 then causes the private key to be unlocked for use. The user's mobile device 302 then generates an authentication response signed by the user's private key and transmits it to the service platform 304. The FIDO server 322 at the service platform 304 receives the signed authentication response and validates that response (using the stored public key associated with the registered user). Once the user and the user's mobile device 302 are authenticated, a response 324 is issued from the service platform 304 to the issuer A web server 306A which may include a unique issuer ID signed by the certificate of the service platform 304. A record may then be created and stored that associates the issuer ID with the user at the data store 308. In this manner, a user operating a mobile device 302 with a biometric authenticator key may be associated with an issuer A (or other provider needing to authenticate transactions of the user) such that transactions involving the user, the mobile device 302 and the issuer A (and thus issuer A web server 306A) may be authenticated during a transaction using the authentication service platform 304.

FIG. 3B is a flowchart illustrating a process 350 for adding, by a registered user, an entity for which an authentication method may be used in accordance with the multi-factor authentication techniques described herein. In some embodiments, the assurance platform operating as a services platform receives 352 an add entity request message from an entity device (such as an issuer financial institution web server) to add an association between the entity and a registered user and/or the registered user's mobile device such that the multi-factor authentication techniques utilizing secure push authentication technology can be used in association with transactions involving that entity and the registered user. After receiving the add entity request message, the service platform retrieves 354 information and/or data of the registered user and the user's mobile device, and then transmits 356 an authentication request message (which may include a random challenge to authenticate the user) to the user's mobile device (for example, by utilizing a mobile telephone number of the user's mobile telephone).

In some cases, a biometric authentication application resident on the user's mobile device receives the authentication request and prompts the user to perform a biometric authentication process. If the user is authenticated by the mobile device then an interaction occurs with a FIDO client on the mobile device that causes the private key to be unlocked for use. The user's mobile device then responds to the authentication request message by transmitting an authentication response signed by the user's private key to the service platform.

Referring again to FIG. 3B, a FIDO server of the service platform receives 358 the authentication response from the user's mobile device that is signed by the user's private key. The assurance platform FIDO server validates 360 the signed authentication response (by using the stored public key associated with the registered user). Once the registered user and the user's mobile device are authenticated, the assurance service platform transmits 362 a response to the entity confirming the addition of the entity along with a unique entity identifier (ID) signed by the certificate of the assurance service platform. For example, with reference to FIG. 3A, the service platform, after authenticating the registered user and/or the user's mobile device, transmits a confirmation message informing the issuer A web server 306A that issuer A has been added, and including a unique issuer ID signed by the certificate of the service platform 304. Next, the assurances service platform creates and stores 364 a record that associates the unique entity ID with the registered user in a data store. In this manner, the assurance service platform adds an entity by associating a registered user and the user's mobile device with the additional entity so that when a transaction occurs that involves the registered user, the user's mobile device and the added entity, the multi-factor authentication techniques utilizing secure push authentication technology described herein can be used for the transaction.

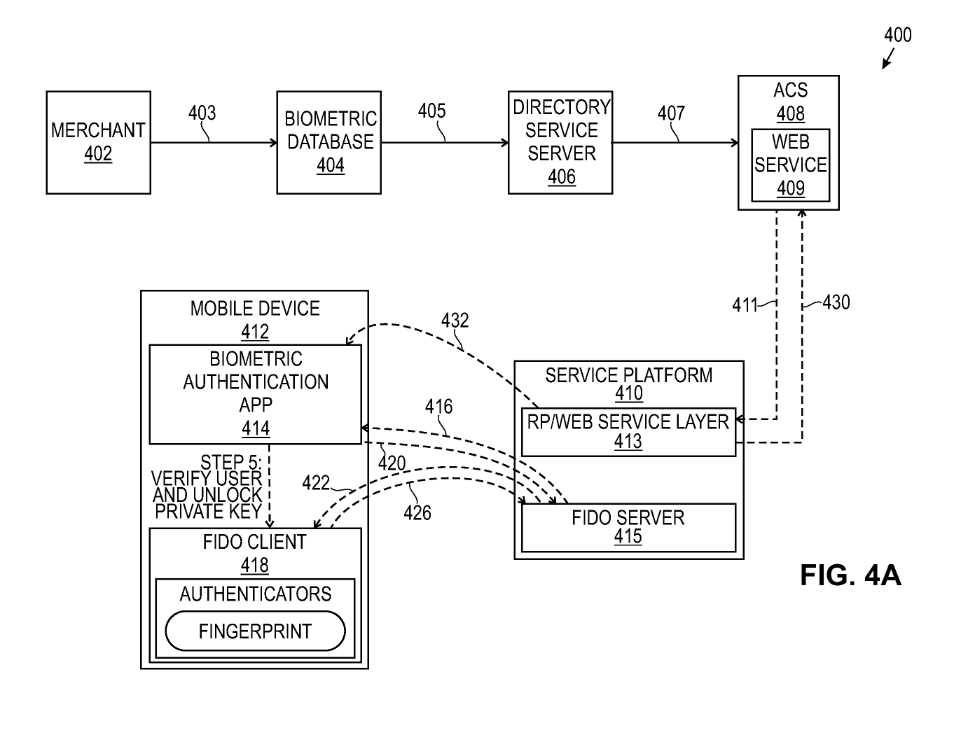

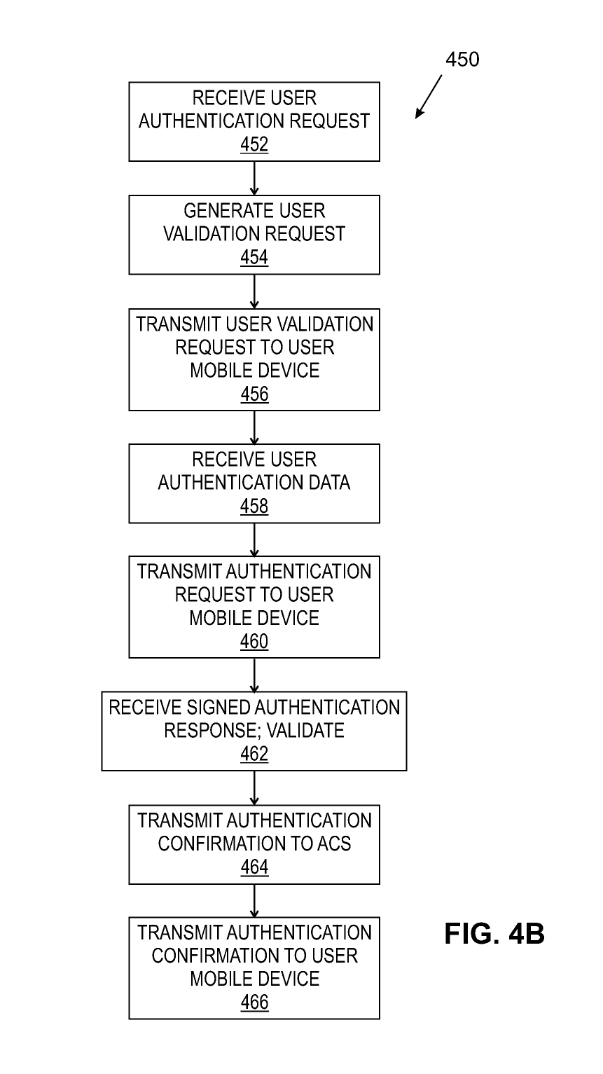

FIG. 4A is a block diagram of a portion of a transaction system 400 for use in performing a transaction in accordance with some embodiments. This example illustrates a financial transaction between a user (consumer) and a merchant that generally follows the 3D Secure process. In some embodiments, a number of different entities and/or devices may be involved in a particular financial transaction such as a merchant device 402, a biometric database 404, a directory service server 406, an access control server (ACS) 408, the authentication as a service platform 410, and the user's mobile device 412. Thus, in some implementations, SOAP and/or REST application control programs may be utilized for communications between the merchant device 402, biometric database 404, directory service server 406, and the access control server (ACS) 408. In addition, the FIDO protocol may be utilized to facilitate communications between the ACS 408, service platform 410 and the user mobile device 412. Furthermore, the Security Assertions Markup Language (SAML) protocol may be utilized for communications between the service platform 310 and the ACS 408. Full details of a payment transaction will not be provided herein, however, during a payment transaction (wherein the user is purchasing a good (merchandise) or service from a merchant), the user may need to be authenticated. In accordance with methods described herein, the nature of the authentication that is required for a financial transaction may be determined based on a user identifier or consumer identifier. Examples of user or consumer identifiers include, but are not limited to, the user's mobile phone number and/or the user's primary account number (“PAN,” which may correspond to a credit card account or other financial account) or a payment token associated with the user.

Thus, with reference to FIG. 4A, in an implementation the merchant device 402 transmits 403 the user's PAN to the biometric database 404, which determines that there is user biometric data available that can be utilized to authenticate the user or consumer and/or the user's mobile device 412. The biometric database 404 may then transmit 405 the user's PAN to the directory service server 406, which matches the PAN to the issuer financial institution (FI) that issued the user's payment account. The directory service server 406 next transmits 407 an issuer identifier (issuer ID) associated with the user's issuer FI to the access control server (ACS) 408, which utilizes a web service 409 to transmit 411 information such as transaction data and a user authentication request to the web service layer 413 of the service platform 410. The authentication request includes information identifying the nature of the authentication to be performed (which may be specified, for example, in a business policy or business policies specified by an issuer FI of the user's payment card account being used by the user for this particular payment transaction).

In some embodiments, the web service layer 413 of the service platform 410 receives 411 an issuer ID and one or more business policies associated with that issuer FI from the web service 409 of the ACS 408. The business policies may specify, for example, when the user identification information can be fully trusted, when assurance is required and/or when user identification information is not to be trusted. Thus, in some implementations, a level of authentication (such as multi-factor authentication) may also be specified depending on one or more business policies of the issuer. For example, if the user's online purchase transaction involves an amount greater than five hundred dollars ($500), then a business rule associated with the issuer FI may require further assurance of a valid user by requiring fingerprint validation and/or voice print validation in addition to the merchant collecting a CVC code from the user. In another example, if a particular user's online purchase transaction is for an amount less than or equal to twenty-five dollars ($50), then only a CVC code is required with no additional assurance needed.

Referring again to FIG. 4A, once a user authentication request is received from the ACS 409, the service platform 410 causes the FIDO server 415 to generate the appropriate authentication request message and transmit 416 that authentication request to the mobile device 412 (e.g., identifying the nature of the authentication to be performed). The biometric authentication application 414 of the mobile device 412 receives the authentication request message, and then prompts the user (who interacts with the mobile device 412 under control of the biometric authentication application 414) to initiate an authentication process (for example, the biometric authentication application 414 prompts the user to provide a voice print by interacting with a microphone of the mobile device, and/or prompts the user to provide a photograph of the user's face by interacting with a camera of the mobile device). This user authentication data is then transmitted 420 from the mobile device 412 to the FIDO server 415 of the service platform 410 to initiate authentication. The service platform then transmits an authentication request 422, which is received by the FIDO client 418 of the mobile device 412. Once the user has been verified by the mobile device 412, the FIDO client 418 obtains the relevant private key, then generates and signs an authentication response with the user's private key. The signed authentication response is then transmitted to the service platform 410 for further processing. Thus, the determination of what biometric data to collect from the user in response to the user authentication request may be based on the business policy of the issuer FI and then provided to the service platform 410.

Pursuant to some embodiments, the biometric assurance application 414 of the user's mobile device may be configured to provide local storage (not shown) of certain collected authentication data. For example, the biometric assurance application 414 may be configured to validate collected authentication data (biometric data) such that the interaction between the mobile device 412 and the service platform 410 involves the transmission of a success or a fail message along with information associated with the authentication data. In some embodiments, however, the biometric assurance application 414 passes the collected authentication data (biometric data) to the service platform 410 for validation and/or authentication processing.

Once the user has been authenticated, an authentication confirmation message, which may be generated in the form of a SAML token, is transmitted 430 from the web service layer 413 of the assurance service platform 410 to the ACS 408 to allow the payment transaction to be completed. In some embodiments, the SAML token is also transmitted 432 to the mobile device 412 as an indication that the payment transaction processing is continuing. It should be understood that embodiments allow such biometric authentication processes to be used in conjunction with a wide variety of different types of transactions. Furthermore, business rules may define what type and/or level of authentication is to be used for a given transaction with a given device. The result is a system and method that provides multi-factor authentication with a wide variety of authentication techniques.

FIG. 4B is a flowchart illustrating an example of a multi-factor authentication process 450 using secure push authentication technology in accordance with some embodiments of the disclosure. In particular, the web service layer of assurance platform operating as an authentication service platform receives 452 a user authentication request along with transaction information from an access control server (ACS). The transaction information identifies the nature of the authentication to be performed (which may be specified, for example, in a business policy or business policies specified by an issuer FI of the user's payment card account being used by the user for this particular payment transaction). Thus, in some embodiments, the web service layer of the service platform receives an issuer ID and one or more business policies associated with that issuer FI from the ACS. The business policies may include, for example, rules that specify when the user identification information can be fully trusted, and/or rules that specify when assurance is required and/or rules that specify when user identification information is not to be trusted. In some implementations, multi-factor authentication may be specified depending on one or more business policies of an entity, such as the issuer of the user's payment card account.

Referring again to FIG. 4B, after a user authentication request is received from the ACS, a FIDO server of the service platform generates 454 a user validation request message which indicates the nature of the authentication to be performed. The user validation request message is then transmitted 456 to the user's mobile device. The user then interacts with his or her mobile device and provides biometric data (via interaction with one or more authenticators). If valid biometric data is provided to one or more authenticator(s) of the user's mobile device receives, then the FIDO server of the assurance platform operating as a service platform receives 458 user authentication data from the mobile device to initiate authentication. When the assurance platform operating as a service platform authenticates the user (for example, by comparing the received biometric data with data of that registered user which is stored in a biometric database and determining that the received data matches the stored data), then the assurance platform next transmits 460 an authentication request to a FIDO client of the mobile device. The FIDO client of the assurance platform then obtains the relevant private key for signing the authentication response. Next, the assurance platform operating as a services platform receives 462 a signed authentication response to the authentication request from the user's mobile device, and upon validating the signed authentication response, the assurance platform transmits 464 an authentication confirmation message (which may be in the form of a SAML token) to the ACS. The ACS then conducts further processing with regard to the transaction between the user and the entity (for example, a merchant). In some embodiments, the service platform also transmits 466 the authentication confirmation message (which also may be in the form of a SAML token) to the user's mobile device as an indication that the payment transaction processing is continuing.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. An assurance platform authentication process, comprising:
receiving, by an assurance platform operating as an authentication service platform, a user authentication request and transaction data from an access control server (ACS);
determining, by the assurance platform, based on the user authentication request an authentication rule concerning a policy associated with an entity;
generating, by the assurance platform based on the authentication rule, a user validation request message;
transmitting, by the assurance platform to a user mobile device, the user validation request message;
receiving, by the assurance platform from the user mobile device, user authentication data;
validating, by the assurance platform, the user authentication data;
transmitting, by the assurance platform to the user mobile device, a device authentication request;
receiving, by the assurance platform from the user mobile device, a device authentication response signed with a private key of the user; and
authenticating, by the assurance platform, the user based on the device authentication response and private key.

2. The method of claim 1, further comprising transmitting, by the assurance platform to the ACS, a confirmation message indicating authentication of the user for the transaction with the entity.

3. The method of claim 1, further comprising transmitting, by the assurance platform to the user mobile device, a confirmation message indicating that further transaction processing will occur.

4. The method of claim 1, wherein the authentication rule specifies at least one type of biometric data to be provided by the user in conjunction with authenticators of the user's mobile device for user authentication processing.

5. The method of claim 1, wherein the user validation request message indicates the nature of the authentication to be performed by a user.

6. The method of claim 1, wherein the policy associated with an entity comprises at least one of rules concerning when the user identification information can be fully trusted, rules concerning when assurance is required, and rules concerning when user identification information is not to be trusted.

7. A transaction system, comprising:
an access control server (ACS);
an assurance platform configured for operating as an authentication service platform and configured for communications with the ACS; and
a user mobile device configured for communications with the assurance platform;
wherein the assurance platform further comprises a FIDO server and a Web service layer, and wherein the FIDO server and the Web service comprise instructions configured to cause the assurance platform to:
receive a user authentication request and transaction data from the ACS;
determine based on the user authentication request an authentication rule concerning a policy associated with an entity;
generate a user validation request message based on the authentication rule;
transmit the user validation request message to a user mobile device;
receive user authentication data from the user mobile device;
validate the user authentication data;
transmit a device authentication request to the user mobile device;
receive a device authentication response signed with a private key of the user from the user mobile device; and
authenticate the user based on the device authentication response and private key.

8. The system of claim 7, wherein the FIDO server and the Web service comprise further instructions configured to cause the assurance platform to transmit a confirmation message to the ACS, the confirmation message indicating authentication of the user for the transaction with the entity.

9. The system of claim 7, wherein the FIDO server and the Web service comprise further instructions configured to cause the assurance platform to transmit a confirmation message to the user mobile device, the confirmation message indicating that further transaction processing will occur.

10. The system of claim 7, wherein the authentication rule specifies at least one type of biometric data to be provided by the user in conjunction with authenticators of the user's mobile device for user authentication processing.

11. The system of claim 7, wherein the user validation request message indicates the nature of the authentication to be performed by a user.

12. The system of claim 7, wherein the policy associated with an entity comprises at least one of rules concerning when the user identification information can be fully trusted, rules concerning when assurance is required, and rules concerning when user identification information is not to be trusted.

13. An assurance platform device registration process comprising:
receiving, by an assurance platform operating as a service platform from a mobile device of a user, a registration request message comprising user data;
processing, by the assurance platform operating as a service platform, the registration request message;
transmitting, by the assurance platform operating as a service platform, a challenge message to the user's mobile device;
receiving, by the assurance platform operating as a service platform in response to the challenge message, a public key from the user mobile device;
storing, by the assurance platform operating as a service platform, the public key in association with the user data; and
setting, by the assurance platform operating as a service platform, an On-Behalf-Of (OBO) service flag to “true” indicating at least one of that biometric data is available and that biometric data is stored for the user mobile device for authentication purposes.

14. The method of claim 13, wherein receiving the authentication registration request comprises communicating, by the assurance platform, with a biometric authentication application operating on the user's mobile device.

15. The method of claim 13, wherein the authentication registration request message comprises mobile device data which identifies the user's mobile device.

16. The method of claim 15, further comprising, determining, by the assurance platform operating as a service platform, the type of user mobile device by make and/or model based on the mobile device data.

17. The method of claim 16, further comprising, identifying, by the assurance platform operating as a service platform, at least one types of authentication hardware component available on the user's mobile device based on the type of user mobile device.

18. The method of claim 13, wherein receiving the public key further comprises receiving, by the assurance platform operating as a service platform, a mobile device ID and a mobile directory number (“MDN”).

19. The method of claim 13, wherein processing the registration request message comprises:
routing, by the assurance platform, the registration request message to a FIDO server component; and
generating, by the FIDO server component, registration request challenge message for transmission to the user's mobile device to prompt the user to provide biometric data for use in authentication.

20. An assurance platform registration system comprising:
a user mobile device comprising at least one authenticator and a storage device; and
an assurance platform configured for communications with the user mobile device;
wherein the assurance platform is configured for operating as a service platform, and configured to:
receive a registration request message comprising user data from the user mobile device;
process the registration request message;
transmit a challenge message to the user mobile device;
receive a public key from the user's mobile device in response to the challenge message;
store the public key in association with the user data; and
set an On-Behalf-Of (OBO) service flag to “true” indicating at least one of that biometric data is available and that biometric data is stored for the user mobile device for authentication purposes.

21. An assurance platform add entity process comprising:
receiving, by an assurance platform operating as a services platform from a user mobile device, an add entity request message to associate an entity with a registered user;
retrieving, by the assurance platform operating as a service platform from a storage device, data identifying the registered user and the user's mobile device;
transmitting, by the assurance platform operating as a service platform, an authentication request message to the user's mobile device;
receiving, by the assurance platform operating as a service platform from the user's mobile device, an authentication response that is signed by the user's private key;
validating, by a FIDO server of the assurance platform, the signed authentication response; and
transmitting, by the assurance platform operating as a service platform to the user's mobile device, a response confirming the addition of the entity, the response comprising a unique entity identifier (ID) signed by a certificate of the assurance service platform.

22. The method of claim 21, further comprising creating and storing, by the assurance platform operating as a service platform in a data store, a record associating the unique entity ID with the registered user.

23. The method of claim 21, wherein validating the signed authentication response comprises utilizing, by the FIDO server, a stored public key associated with the registered user.

24. An assurance platform add entity system comprising:
a user mobile device comprising at least one authenticator; and
an assurance platform configured for communications with the user mobile device, the assurance platform comprising hardware components including a storage device;
wherein the assurance platform is configured for operating as a service platform, and the storage device stores instructions configured to:
receive an add entity request message from the user mobile device to associate an entity with a registered user;
retrieve data identifying the registered user and the user's mobile device from the storage device;
transmit an authentication request message to the user mobile device;
receive an authentication response from the user mobile device that is signed by the user's private key;
validate the signed authentication response by a FIDO server of the assurance platform; and
transmit a response to the user mobile device confirming the addition of the entity, the response comprising a unique entity identifier (ID) signed by a certificate of the assurance service platform.

25. The system of claim 24, wherein the storage device of the assurances platform stores further instructions configured to cause the assurance platform to create and store a record associating the unique entity ID with the registered user.

26. The system of claim 24, wherein validating the signed authentication response comprises utilizing, by the FIDO server, a stored public key associated with the registered user.
